(19) United States
(12) Patent Application Publication
(10) Pub. No.: US 2025/0013887 A1
(43) Pub. Date: Jan. 9, 2025

(54) METHOD, APPARATUS, ELECTRONIC DEVICE AND MEDIUM FOR DETERMINING FAIRNESS IMPACT OF MODEL

(71) Applicant: Lemon Inc., Grand Cayman (KY)

(72) Inventors: Yuanshun Yao, Los Angeles, CA (US); Yang Liu, Los Angeles, CA (US)

(21) Appl. No.: 18/746,832

(22) Filed: Jun. 18, 2024

(30) Foreign Application Priority Data
Jun. 30, 2023 (CN) 202310800831.6

(51) Int. Cl. G06N 5/022

(52) U.S. Cl. CPC G06N 5/022

(57) ABSTRACT

Embodiments of the present disclosure relate to a method, apparatus, electronic device, and medium for determining fairness impact of a sample on a model. The method comprises generating a counterfactual sample by adjusting an original sample in an original sample set, the original sample set being used for generating an original model for performing a classification task. The method further comprises determining a fairness metric of the original model on a validation sample set. In addition, the method further comprises determining fairness impact of the original sample on the original model based on the fairness metric, the original sample, and the counterfactual sample.

### CROSS-REFERENCE TO RELATED APPLICATION(S)

This application claims priority to Chinese Application No. 202310800831.6 filed on Jun. 30, 2023, the disclosures of which is incorporated herein by reference in its entity.

### FIELD

The present disclosure generally relates to the field of artificial intelligence, and more specifically to a method, apparatus, electronic device, and medium for determining fairness impact of a sample on a model.

### BACKGROUND

During constant development and popularization of application of artificial intelligence, people begin to pay attention to the impact of an algorithm and a model on social fairness. Unfair treatment of individuals with different population attributes (also known as sensitive attributes) might lead to problems such as increased social inequalities. Therefore, there is an urgent need to ensure the fairness of models to protect the right and interests of individuals and populations. In the field of artificial intelligence, fairness may involve multiple aspects. For example, when a model is trained, it is requisite to ensure the representativeness and diversity of training samples, and ensure that the algorithm does not favor or discriminate against individuals from different populations, etc.

### SUMMARY

Embodiments of the present disclosure provide a method, apparatus, electronic device, and medium for determining fairness impact of a sample on a model. For a set of training samples for training a model, the method according to embodiments of the present disclosure provide methods may adjust an original training sample in a number of ways to generate a counterfactual sample corresponding to the sample. The method may then calculate the impact on the fairness of the model when the counterfactual sample is used to train the model.

In a first aspect of embodiments of the present disclosure, there is provided a method for determining fairness impact of a sample on a model. The method comprises generating a counterfactual sample by adjusting an original sample in an original sample set, the original sample set being used for generating an original model for performing a classification task. The method further comprises determining a fairness metric of the original model on a validation sample set. In addition, the method further comprises determining fairness impact of the original sample on the original model based on the fairness metric, the original sample, and the counterfactual sample.

In a second aspect of embodiments of the present disclosure, there is provided an apparatus for determining fairness impact of a sample on a model. The apparatus comprises a counterfactual sample generating module configured to generate a counterfactual sample by adjusting an original sample in an original sample set, the original sample set being used for generating an original model for performing a classification task. The apparatus further comprises a fairness metric determining module configured to determine a fairness metric of the original model on a validation sample set. In addition, the apparatus further comprises a fairness impact determining module configured to determine fairness impact of the original sample on the original model based on the fairness metric, the original sample, and the counterfactual sample.

In a third aspect of the present disclosure, there is provided an electronic device. The electronic device comprises one or more processor; and a storage device for storing one or more programs which when executed by the one or more processors, cause the one or more processor to implement a method for determining fairness impact of a sample on a model. The method comprises generating a counterfactual sample by adjusting an original sample in an original sample set, the original sample set being used for generating an original model for performing a classification task. The method further comprises determining a fairness metric of the original model on a validation sample set. In addition, the method further comprises determining fairness impact of the original sample on the original model based on the fairness metric, the original sample, and the counterfactual sample.

In a fourth aspect of the present disclosure, there is provided a computer readable storage medium in which is stored a computer program which when executed by a processor, implements a method for determining fairness impact of a sample on a model. The method comprises generating a counterfactual sample by adjusting an original sample in an original sample set, the original sample set being used for generating an original model for performing a classification task. The method further comprises determining a fairness metric of the original model on a validation sample set. In addition, the method further comprises determining fairness impact of the original sample on the original model based on the fairness metric, the original sample, and the counterfactual sample.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

The above and other features, advantages and aspects of embodiments of the present disclosure will become more apparent through the following detailed depictions with reference to the following figures. In the figures, like or similar reference numerals denote like or similar elements, wherein:

FIG. 1 illustrates a schematic diagram of an example environment in which embodiments of the present disclosure may be implemented;

FIG. 2 illustrates a flow chart of a method for determining fairness impact of a sample on a model according to some embodiments of the present disclosure;

FIG. 3A through FIG. 3D illustrate an overall causal diagram relating to concepts and causal diagrams corresponding to intervening population attributes, intervening features, and intervening labels according to some embodiments of the present disclosure;

FIG. 4 illustrates a schematic diagram of a process for improving model fairness through intervening population attributes according to some embodiments of the present disclosure;

FIG. 5A-FIG. 5C illustrate schematic diagrams of a process for generating counterfactual samples through the intervening population attributes, intervening features and intervening labels according to some embodiments of the present disclosure;

FIG. 6 illustrates a block diagram of an apparatus for determining an fairness impact of a sample on a model according to some embodiments of the present disclosure; and

FIG. 7 illustrates a block diagram of an apparatus capable of implementing a plurality of embodiments of the present disclosure.

### DETAILED DESCRIPTION

It is to be understood that all data related to a user involved in the present technical solution should be acquired and used after being authorized by the user. This means that, in the present technical solution, if personal information about a user needs to be used, explicit consent and authorization of the user are required before obtaining such data, otherwise relevant data collection and use will not be performed. It should also be understood that in the implementation of this technical solution, relevant laws and regulations should be strictly observed during the collection, use and storage of data, and necessary techniques and metrics should be taken to ensure the safety of data for users and the safe use of data.

Embodiments of the present disclosure will be described in more detail below with reference to the accompanying drawings. While certain embodiments of the present disclosure have been shown in the accompanying drawings, it is to be understood that the present disclosure may be embodied in various forms and should not be construed as being limited to the embodiments set forth herein, and instead, these embodiments are provided to provide a more thorough and complete understanding of the present disclosure. It should be understood that the drawings and embodiments of the present disclosure are for illustration purposes only and are not intended to limit the scope of the present disclosure.

In the depictions of the embodiments of the present disclosure, the term “include” and its like should be understood to be open-ended, i.e., “include but not limited to”. The term “based on” should be understood as “based at least in part on. The term “one embodiment” or “the embodiment” should be understood as “at least one embodiment”. The terms “first”, “second” and the like, may refer to different or the same object unless explicitly stated otherwise. Other explicit and implicit definitions are also possibly included in the following text.

A fundamental problem with fairness of machine learning is the source of unfairness. In practice, this is also one of the problems that practitioners put forward first after calculating the fairness metric and finding the model unfair. While this problem sounds simple, it is difficult to determine the exact source of unfairness in a machine learning process. There might be many possible reasons for unfairness in an artificial intelligence model, including insufficient training data, lack of features, erroneous prediction goals, or inaccurate measurements of input features. Even for the most experienced artificial intelligence researchers and engineers, these problems are not so easy to solve.

The sources of unfairness are many, including data sampling bias or under-representation, data labeling bias, model architecture (or feature representation), distribution shift etc. Embodiments of the present disclosure focus on the most important and obvious source of bias—the training samples. It is because if the training samples of the model are biased, then it would be unlikely that it is very difficult for the model trained with these training samples to have high fairness unless the model is modified by paying high costs. Specifically, embodiments of the present disclosure concern how training samples would impact the unfairness of the model by paying attention to the following problems: how a fairness metric of the model would change if the training samples of the model were collected from different (e.g. demographic) populations; how a fairness metric of the model would change if the training samples of the model were labelled as different values; how a fairness metric of the model would change if values of some features of the training samples of the model were changed. Answering those questions can help practitioners explain the cause of the unfairness of the model in terms of training data, repair the training data to improve fairness, and detect biased or noisy training labels, under-represented population, and corrupted features that hurt fairness.

To this end, according to an embodiment of the present disclosure, a scheme for determining fairness impact of a sample on a model is provided. The scheme involves an original sample set, a validation sample set, and an original model trained using the original sample set. The scheme generates counterfactual samples by adjusting the original samples in the original sample set, and then first determines the fairness metric of the original model on the validation sample set, and then determines the fairness impact of the original samples on the original model based on the fairness metric, the original samples and the counterfactual samples. In this manner, the impact of each training sample on model fairness can be determined, helping practitioners accurately locate those training samples that have the greatest impact on model fairness so that practitioners can improve model fairness by repairing these training samples.

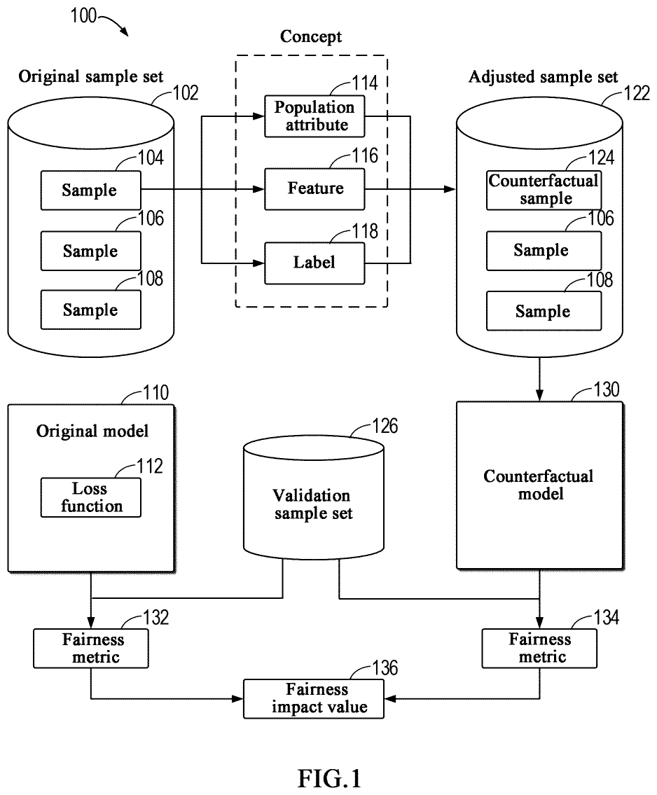

FIG. 1 illustrates a schematic diagram of an example environment 100 in which various embodiments of the present disclosure can be implemented. As shown in FIG. 1, environment 100 comprises an original sample set 102 that comprises original samples 104, 106, and 108, etc. The original sample set 102 may comprise any number of original samples. Only three original samples are shown in FIG. 1 for sake of simplicity, which however is not intended to limit the number of original samples in original sample set 102. The environment 100 further comprises an original model 110. The original model is a model based on an original sample set 102 and trained using a loss function 112. The original model 110 is a classification model for performing classification tasks, which may include, for example, image classification, video classification, content classification, etc. For example, a machine learning task performed by the original model 110 may be to predict a user interest preference (e.g., to predict whether the user is interested in content related to a car). Each original sample in the original sample set 102 has a population attribute, a feature, and a label. For example, as shown in FIG. 1, the original sample 104 comprises a population attribute 114, a feature 116 and a label 118. The population attribute may be, for example, a region of residence of a user, etc., the feature 116 may be, for example, whether or not the number of times of outing has exceeded 10 in the past year, etc. and the label 118 may be, for example, that the user is interested or not interested in a car, etc. In embodiments of the present disclosure, the original sample set may include various structured data and unstructured data (e.g., image data, text data, and speech data), etc. Embodiments of the present disclosure do not limit in this regard as long as the data is suitable for an artificial intelligence model to perform processing such as training and prediction.

In the text herein, the population attribute, feature, and label are collectively referred to as a “concept”, which refers to a categorical variable that describes data property. For example, in some embodiments, it is possible to choose the population attribute as the concept, then counterfactually intervene on the population attribute to answer the question “what is the fairness impact if training data were sampled from a different population?” In some embodiments, it is possible to choose the feature 116 as the concept, and then counterfactually intervene on the feature 116 to answer the question “how will the fairness metric of the model change if values of some features of the training samples of the model are changed”. In some embodiment, it is also possible to choose the label 118 as the concept, and then counterfactually intervene on the label 118 to answer the question “what impact will be exerted on the fairness of the model if the value of the label of the training sample is changed”. In some embodiments, it is also possible to choose the existence of the training sample as the concept, and then observe the impact on the fairness of the model by, for example, marking the original sample 104 as removed. For example, in environment 100, counterfactual intervening may be performed on the population attributes 114, feature 116, or label 118 of the original sample 104 to generate a counterfactual sample 124, and then an adjusted sample set 122 may be generated by using the counterfactual sample 124 in place of the original sample 104. The adjusted sample set 122 comprises the counterfactual sample 124, the original sample 106, and the original sample 108.

As shown in FIG. 1, the counterfactual model 130 is a model corresponding to the adjusted sample set 122. The counterfactual model 130 is not necessarily a truly trained model, and it may also represent that the counterfactual model 130 will be obtained if the adjusted sample set 122 is used for training. In the environment 100, it is possible to respectively determine a fairness metric 132 of the original model 110 on the validation sample set 126 as well as a fairness metric 134 of the counterfactual model 130 on the validation sample set 126, and then determine a fairness impact value 136 based on the fairness metrics 132 and 134.

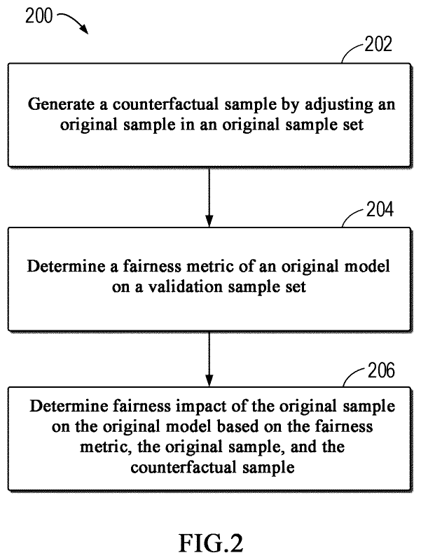

FIG. 2 illustrates a flow chart of a method 200 for determining fairness impact of a sample on a model according to some embodiments of the present disclosure. As shown in FIG. 2, at block 202, the method 200 comprises generating a counterfactual sample by adjusting original samples in an original sample set, the original sample set being used to generate an original model for performing a classification task. For example, in the environment 100 shown in FIG. 1, the original sample set 102 is used to generate the original model 110, and the method 200 may intervene on the concepts (e.g., the population attribute 114, feature 116, label 118, or marking the original samples 104 as removed) of the original samples 104 in the original sample set 102 to thereby generate the counterfactual sample 124.

At block 204, the method 200 may determine a fairness metric of the original model on the validation sample set. For example, in the environment 100 shown in FIG. 1, the method 200 may determine the fairness metric 132 of the original model 110 on the validation sample set 126. The fairness metric 132 is a value that can quantify the fairness of the original model 110 on the validation sample set 126, and an approximate solution to the fairness metric 132 can be obtained by calculating a substitution loss of the original model 110 on the validation sample set 126. The validation sample set 126 is a sample set independent of the original sample set 102, and comprises representative samples from various populations. Calculating the fairness metric 132 on the validation sample set 126 may provide an evaluation of the fairness performance of the original model 110 on the real data to examine the performance of the model in the real environment.

At block 206, the method 200 may determine the fairness impact of the original sample on the original model based on the fairness metric, the original sample, and the counterfactual sample. For example, in the environment 100 shown in FIG. 1, the fairness impact of the intervention of the original sample 104 on the original model 110 may be represented by a fairness impact value 136 that indicates the difference between the fairness metric 132 of the original model 110 on the validation sample set 126 and the fairness metric 134 of the counterfactual model on the validation sample set 126. However, in some embodiments, the counterfactual model 130 is not really obtained by training, and therefore the fairness metric 134 cannot be determined directly. Thus, the method 200 may calculate an approximate solution to the fairness impact value 136 based on the fairness metric 132 of the original model 110 on the validation sample set 126, the original sample 104, and the counterfactual sample 124.

In this manner, the method 200 can determine the fairness impact of each original sample on the original model 110 by making adjustments or intervention to each original sample in the original sample set 102, thereby helping practitioners accurately locate the set of samples in the original sample set 102 that have the greatest fairness impact on the original model 110 so that practitioners can improve the fairness of the model by repairing these training samples.

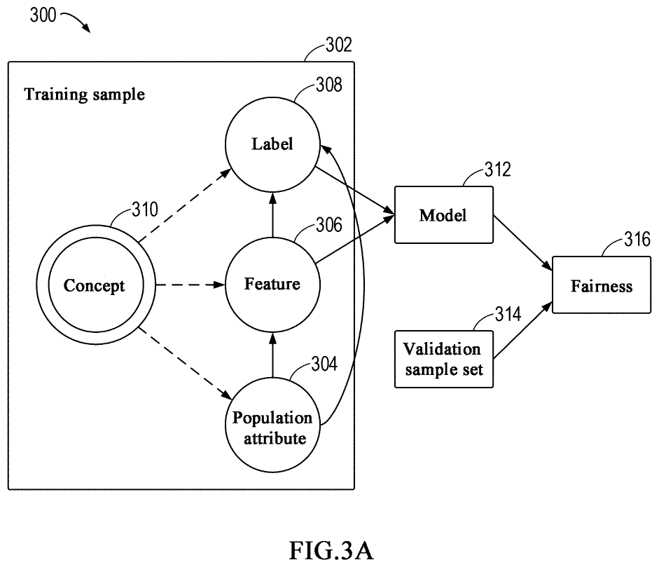

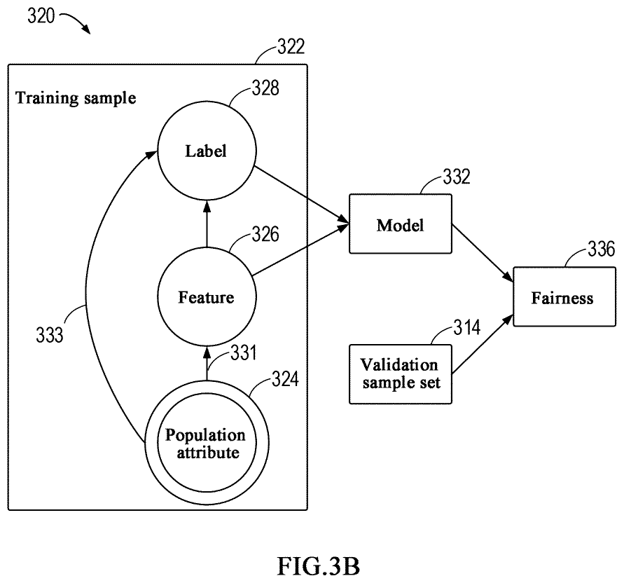

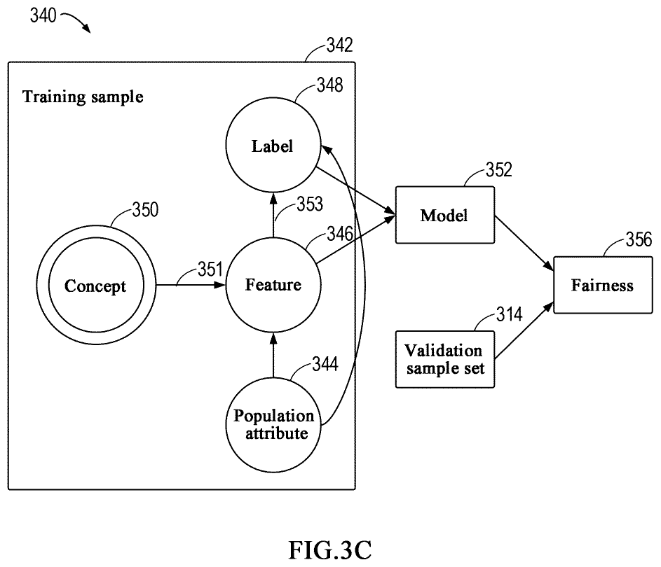

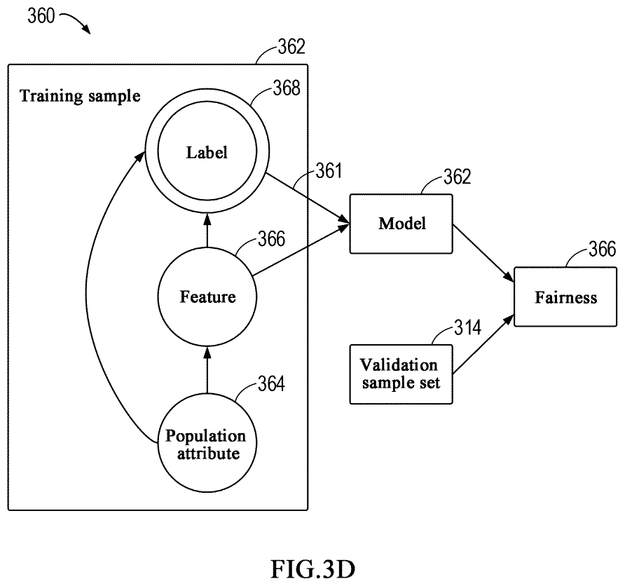

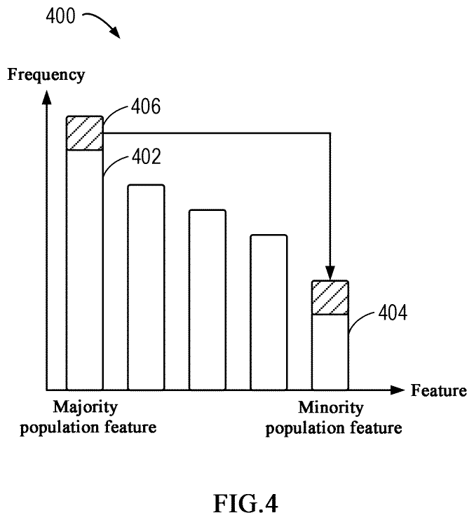

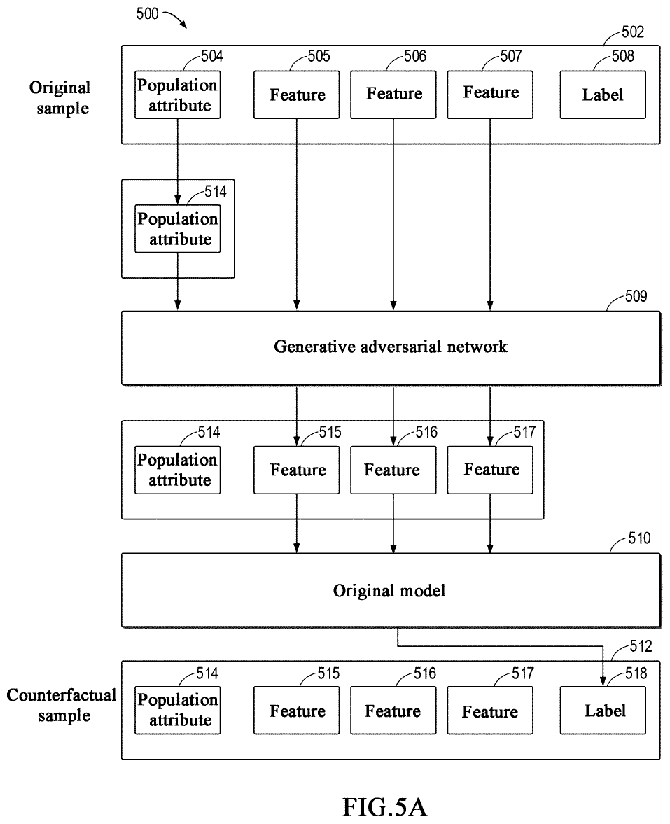

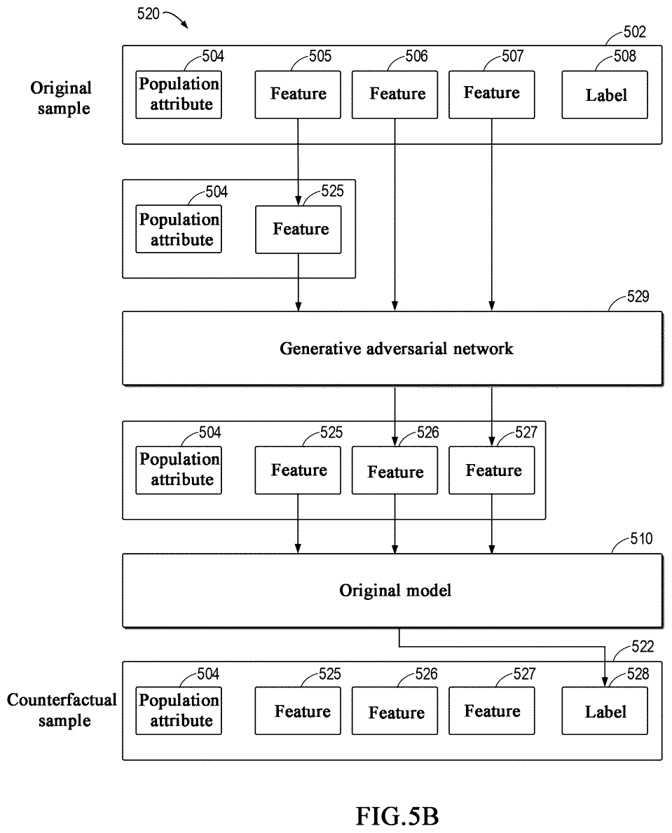

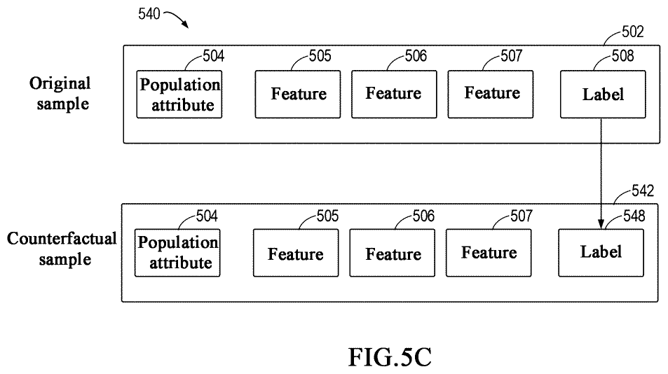

An overall causal diagram relating to concepts and a plurality of causal diagrams corresponding to intervening population attributes, intervening features, and intervening labels according to some embodiments of the present disclosure will be described with reference to FIG. 3A through FIG. 3D. Then, a detailed process of determining the fairness impact value is introduced. In addition, a process for improving model fairness by the intervening population attributes according to some embodiments of the present disclosure will also be introduced by way of example with reference to FIG. 4. In addition, different processes for generating counterfactual samples according to some embodiments of the present disclosure will be described with reference to FIG. 5A through FIG. 5C.

FIG. 3A illustrates an overall causal diagram 300 relating to concepts according to some embodiments of the present disclosure. In the causal graph, a node represents a variable or factor, and the variable may be an observable variable or a non-observable potential variable. An edge represents a causal or dependent relationship between variables. As shown in FIG. 3A, a training sample 302 comprises a population attribute 304, a feature 306 and a label 308, wherein the feature 306 may include a plurality of features. In other places in the text herein, the population attribute is also denoted by A, the feature is denoted by X, and the label is denoted by Y. the concept 310 is a sample-level classification attribute associated with the training sample 302. Formally, the concept is represented by C∈ [symbol] :={1, 2 . . . , c}, where C is a discrete concept encoded in the data (X, Y, A). The casual graph 300 illustrates how to quantify the impact of replacing an original sample (e.g., original sample 104 in FIG. 1) with a counterfactual sample (e.g., counterfactual sample 124 in FIG. 1) when intervening on a concept (e.g., population attribute 304, feature 306, or label 308). As shown in FIG. 3A, in the casual diagram 300, the feature 306 depends on the population attribute 304, the label 308 depends on the feature 306 and the population attribute 304, a model 312 depends on the feature 306 and label 308, and fairness 316 depends on the model 312 and a validation sample set 314.

FIG. 3B illustrates a causal diagram 320 when a population attribute of a sample is intervened, according to some embodiments of the present disclosure. The population attribute is closely related to fairness metrics because the population attribute may control the sampling distribution of each population. As shown in FIG. 3B, in the causal diagram 320, the population attribute 324 is selected as a concept being intervened, which means exploring what fairness impact is caused if a training sample 322 comes from a different population. When the population attribute 302 is intervened (e.g., changed from one value to another), the intervening may affect the value of each feature 326 (as indicated by arrow 331), and meanwhile the intervention may also affect the value of the label 328 (as indicated by arrow 333). For example, when the population attribute of the user is changed, whether the number of times of the user outing exceeds 10 in the past year may be affected, and meanwhile whether the user is interested in the car-related content (namely, the label) may also be affected. Since the model 332 depends on the feature 326 and the label 328, when the feature 326 and the label 328 change, the model 332 changes, and fairness 336 changes accordingly.

FIG. 3C illustrates a causal graph 340 when a feature of a sample is intervened, according to some embodiments of the present disclosure. As shown in FIG. 3C, in a causal graph 340, a feature of a training sample 342 is selected as the concept 350. When the feature is intervened, the population attribute 344 of the training sample 342 is not affected because the population attribute 344 is independent of the feature 346. However, intervening on one feature of the training sample 342 may affect the values of all other features 346 (as indicated by arrow 351). In addition, since the feature 346 is affected, the value of the label 348 is also affected (as indicated by arrow 353). For example, when whether the number of times of the user outing exceeds 10 (namely, the feature) in one year changes from “YES” to “NO”, the other features of the user and whether the user is interested in the car-related content (namely, the label) may be affected. Since the model 352 depends on the feature 346 and the label 348, as the feature 346 and the label 348 change, the model 352 changes, and fairness 356 changes accordingly. The intervention on the feature means that the model will become fairer when the set of collected training samples has different values for the same feature.

FIG. 3D illustrates a causal graph 340 when a feature of a sample is intervened according to some embodiments of the present disclosure. As shown in FIG. 3C, in the causal graph 360, a label 368 of a training sample 362 is selected as a concept. Since neither the population attribute 364 nor the feature 366 is dependent on the label 368, neither the population attribute 364 nor the feature 366 of the training sample 362 is affected when the label 368 is intervened. However, since the model 362 depends on the label 368, the intervention may affect the model 362 (as indicated by the arrow 362), and accordingly the fairness 366 may change. In many cases, there is uncertainty in the label of the sample, and sometimes the observed label may be encoded with noise, an inaccurate mark or a subjective deviation, so the intervention on the label means a counterfactual effect, i.e., the impact of the intervening on the result is evaluated by comparing an observed real-world situation with an assumed alternative situation.

In addition to the three cases shown in FIG. 3B through FIG. 3D, the concept may further be removing the training sample from a data set. In some embodiments, it may be considered that each sample has a selection variable with a value of 0 or 1, and the selection variable of the sample that occurs in the training sample set has a value of 1; if the value is changed to 0, this means that the sample is counterfactually excluded from the training sample set. In this way, the fairness impact of the intervention on the model can be evaluated by comparing the presence or absence of a sample in the training sample set.

In some embodiments, to determine the fairness impact of the intervened original sample on the model, a loss for the original sample (also referred to as a first loss) may be determined based on the original sample and by using a loss function for generating the original model, a loss for the counterfactual sample (also referred to as a second loss) may be determined based on the counterfactual sample and using the loss function, and a fairness impact value indicating the fairness impact of the original sample on the original model may be determined based on a fairness metric of the original model on a verification data set, the loss for the original sample, and the loss for the counterfactual sample.

In some embodiments, to determine a fairness impact value, a loss function for training the original model may be utilized to generate a plurality of losses corresponding to a plurality of original samples in the original sample set, a Hessian Matrix for the original model may be determined based on the plurality of losses, and the fairness impact value is determined based on the Hessian Matrix, the fairness metric of the original model on the verification data set, the losses for the original samples, and the losses for the counterfactual samples.

In the text herein, Dₜᵣₐᵢₙ={zᵢ^{tr}=(xᵢ^{tr},yᵢ^{tr})}ᵢ₌₁ⁿ is used to represent the training, sample set, where zᵢ^{tr} represents the i^{th} training sample, xᵢ^{tr} represents the feature of zᵢ^{tr}, and yᵢ^{tr} represents the label of zᵢ^{tr}; Dᵥₐₗ={zᵢ^{val}=(xᵢ^{val},yᵢ^{val})}ᵢ₌₁ⁿ is used to denote a validation sample set, where zᵢ^{val} represents the i^{th} validation sample, xᵢ^{val} represents the feature of zᵢ^{val}, yᵢ^{val} represents the label of zᵢ^{val}. It is assumed that the model is parameterized as θ∈Θ and there is a subset of the training sample set that the sample index is [symbol] ={K₁, . . . , Kₖ}. If the group [symbol] is scrambled by assigning a weight wᵢ∈[0, 1] to each sample i∈ [symbol] , \hat{θ} [symbol] is used to represent the generated counterfactual model. The fairness impact infl(Dᵥₐₗ, [symbol] , \hat{θ}) of the reweighted group [symbol] in the training data on the model is defined as a difference in the fairness metric between the original model \hat{θ} (trained on the complete training data) and the counterfactual model \hat{θ} [symbol] . infl(Dᵥₐₗ, [symbol] , \hat{θ}) may be expressed using Equation (1):

$$infl ( {D}_{avl} , 𝒦 , \hat{θ} ) := {ℓ}_{fair} ( \hat{θ} ) - {ℓ}_{fair} ( {\hat{θ}}_{𝒦} ) \qquad ( 1 )$$

where l_{fair} represents the fairness metric.

A closed-form solution to the fairness impact can be derived according to Equation (1). The first-order approximation of (1) may take the form of Equation (2) below:

$$infl ( {D}_{val} , 𝒦 , \hat{θ} ) \approx - {∇}_{θ} {{ℓ}_{fair} ( \hat{θ} )}^{⊤} {H}_{\hat{θ}}^{- 1} ( {\sum }_{i ∈ 𝒦} {w}_{i} ∇ ℓ ( {z}_{i}^{tr} ; \hat{θ} ) ) \qquad ( 2 )$$

where H_{\hat{θ}} is the Hessian matrix for the original model \hat{θ}, i.e.,

$${H}_{\hat{θ}} := \frac{1}{n} {∇}^{2} {{\sum }_{i = 1}^{n}}^{} ℓ ( {z}_{i}^{tr} ; \hat{θ} ) ,$$

and l is the original loss function for training the original model \hat{θ} (e.g., the original loss function may be a cross-entropy loss function in a classification task).

The fairness metric [symbol] _{fair}(\hat{θ}) may quantify the fairness of the trained model \hat{θ}. In some embodiments, an approximate solution of [symbol] _{fair}(\hat{θ}) may be obtained using the surrogate loss of the model on the validation sample set. In these embodiments, the classifier corresponding to the model θ may be expressed as h_{θ}, and the Demographic Parity (DP), as the population fairness metric, may then be approximated by Equation (3) as follows in the form of Equation (4) (assuming that the population attribute A and the classification task are binary):

$${ℓ}_{DP} ( \hat{θ} ) := \vert ℙ ( {h}_{θ} ( X ) = 1 \vert A = 0 ) - ℙ \vert {h}_{θ} ( X ) = 1 \vert A = 1 ) \vert \qquad ( 3 )$$

$$\approx \vert \frac{{\sum }_{i ∈ {D}_{val} : {a}_{i} = 0} g ( {z}_{i}^{val} ; θ )}{{\sum }_{i ∈ {D}_{val}} 𝕀 [ {a}_{i} = 0 ]} - \frac{{\sum }_{i ∈ {D}_{val} : {a}_{i} = 1} g ( {z}_{i}^{val} ; θ )}{{\sum }_{i ∈ {D}_{val}} 𝕀 [ {a}_{i} = 1 ]} \vert \qquad ( 4 )$$

where g is the log it of the predicted probability for class 1, aᵢ is the population attribute of the i^{th} sample.

To quantify the counterfactual effect of changing the concept c for each sample (x, y, a), mathematically, (\hat{x}, ŷ, â) is used to represent the counterfactual sample generated by intervening on the concept c. Given a training sample zᵢ^{tr}:=(xᵢ, yᵢ, aᵢ, cᵢ), the counterfactual sample corresponding to the sample zᵢ^{tr} when intervening on concept C=c′ may be defined by the following Equation (5):

$$\hat{x} ( {c}^{′} ) , \hat{y} ( {c}^{′} ) , \hat{a} ( {c}^{′} ) \sim ℙ ( \hat{X} , \hat{Y} , \hat{A} \vert X = x , Y = y , A = a , do ( C = {c}^{′} ) ) , {c}^{′} \neq c \qquad ( 5 )$$

where do(⋅) represents the do operation in the causal model.

In Equation (5) above, when the concept C overlaps with any one of (X, Y, A), the do(⋅) operation has a higher priority, and is assumed to automatically override the other dependencies. For example, when the concept is the population attribute (i.e., C=A), the following Equation (6) represents do(A=â) has a higher priority:

$$ℙ ( \hat{X} , \hat{Y} , \hat{A} \vert X = x , Y = y , A = a , do ( C = {c}^{′} ) ) = ℙ ( \hat{X} , \hat{Y} , \hat{A} \vert X = x , Y = y , do ( A = \hat{a} ) ) \qquad ( 6 )$$

The counterfactual sample may be expressed as \hat{z}ᵢ^{tr}(c′)=(\hat{x}ᵢ(c′),ŷᵢ(c′),âᵢ(c′),ĉᵢ=c′), then the original sample zᵢ^{tr}:=(xᵢ,yᵢ,aᵢ,cᵢ) is replaced with the counterfactual sample \hat{z}ᵢ^{tr}(c′) in the training data set, the counterfactual model \hat{θ}_{i,c′} trained on the adjusted sample set may be expressed by the following Equation (7):

$${\hat{θ}}_{i , {c}^{′}} := arg {min}_{θ} \{ R ( θ ) - ϵ \cdot ℓ ( θ , {z}_{i}^{tr} ) + ϵ \cdot ℓ ( θ , {\hat{z}}_{i}^{tr} ( {c}^{′} ) ) \} \qquad ( 7 )$$

where R(θ) represents the risk of the model θ and ϵ represents a small positive number.

On the validation sample set Dᵥₐₗ, [symbol] _{fair}(\hat{θ}) is used to represent the fairness metric of the original model \hat{θ}, and [symbol] _{fair}(\hat{θ}_{i,c′}) is used to represent the fairness metric of the counterfactual model \hat{θ}_{i,c′}. When the concept C of the original sample i is intervened as C′, the fairness impact value infl(Dᵥₐₗ,\hat{θ}_{i,c′}) of the original sample on the original model may be expressed by the following Equation (8):

$$infl ( {D}_{val} , {\hat{θ}}_{i , {c}^{′}} ) := {ℓ}_{fair} ( \hat{θ} ) - {ℓ}_{fair} ( {\hat{θ}}_{i , {c}^{′}} ) \qquad ( 8 )$$

In conjunction with Equation (2), an approximate solution to the fairness impact value infl(Dᵥₐₗ,\hat{θ}_{i,c′}) may be calculated by Equation (9) below:

$$infl ( {D}_{val} , {\hat{θ}}_{i , {c}^{′}} ) \approx - {▽}_{θ} {{ℓ}_{fair} ( \hat{θ} )}^{⊤} {H}_{\hat{θ}}^{- 1} ( ▽ℓ ( {z}_{i}^{tr} ; \hat{θ} ) - ▽ℓ ( {\hat{z}}_{i}^{tr} ( {c}^{′} ) ; \hat{θ} ) ) \qquad ( 9 )$$

where [symbol] is the loss function of the original model \hat{θ} and H_{\hat{θ}} is the Hessian matrix of the original model \hat{θ} on the original sample set.

In some embodiments, the product of the second item H_{\hat{θ}}⁻¹ and third item (∇ [symbol] (zᵢ^{tr};\hat{θ})−∇ [symbol] (\hat{z}ᵢ^{tr}(c′);\hat{θ})) in Equation (9) may be calculated using a Hessian vector product (HVP). Let v:=(∇ [symbol] (zᵢ^{tr};\hat{θ})−∇ [symbol] (\hat{z}ᵢ^{tr}(c′);\hat{θ})), H⁻¹v may be recursively calculated by the following Equation (10):

$${\hat{H}}_{r}^{- 1} v = v + ( I - {\hat{H}}_{0} ) {\hat{H}}_{r - 1}^{- 1} v \qquad ( 10 )$$

where Ĥ₀ is the Hessian matrix approximated on a random batch and r is the number of recursive iterations.

Let t be the final recursive iteration, then the final fairness impact value is infl(Dᵥₐₗ,\hat{θ}_{i,c′})≈−∇_{θ} [symbol] _{fair}(\hat{θ})^{τ}Ĥₜ⁻¹v, where [symbol] _{fair}(\hat{θ}) is the surrogate loss of the fairness metric (e.g., Equation (4)).

Alternatively, in some embodiments, when a plurality of counterfactual samples are intervened at a time, \hat{z}ᵢ^{tr}(c′,k), k=1, 2, . . . , E may be used to represent the k^{th} sample of E samples, and an average counterfactual effect may be calculated by

$${\hat{θ}}_{i , {c}^{′}} := arg {min}_{θ} \{ R ( θ ) - ϵ \cdot ℓ ( θ , {z}_{i}^{tr} ) + ϵ \cdot \frac{{\sum }_{k = 1}^{E} ( θ , {\hat{z}}_{i}^{tr} ( {c}^{′} , k ) )}{E} \} .$$

In this way, sample-level intervention or adjustment can be made to samples in the original sample set, and the counterfactual model need not be trained on the adjusted sample set, but an approximate solution to the fairness impact value is determined by calculating the fairness metric of the original model on the validation dataset, the Hessian matrix for the original model, the loss of the original sample calculated using the original loss function, and the loss of the counterfactual sample calculated using the original loss function. Thus, the fairness impact of each sample in the original sample set on the original model can be determined at the sample level by avoiding consuming large computational and resource costs, and the fairness of the model may be improved by repairing samples with larger fairness impact values.

To further illustrate the principle that intervening on the concept (e.g., population attribute, feature, and label) of the sample can improve model fairness, FIG. 4 illustrates, by way of example, a schematic diagram of a process 400 for improving model fairness by intervening on the population attribute according to some embodiments of the present disclosure. As shown in FIG. 4, the horizontal axis of the histogram indicates the features of different populations, and the longitudinal axis indicates the frequency of different populations appearing in the training sample set, wherein the majority population 402 appears most frequently in the training sample set, and the minority population 404 appears least frequently in the training sample set. In the process 400, a portion of populations 406 in the majority population 406 may be intervened, and specifically, the population attribute of each sample in population 406 may be adjusted to the population attribute of minority population 404. By doing so, the process 400 approximates resampling the training sample set, and the frequency of occurrence of different populations of samples in the adjusted sample set is more balanced than the sample set prior to resampling, so that fairness of the model can be improved.

When intervening on the population attribute, feature, or label of the original sample (e.g., original sample 104 in FIG. 1) in the original sample set, a new counterfactual sample (e.g., counterfactual sample 124 in FIG. 1) needs to be generated, and the dependence (as shown in FIGS. 3A through 3D) between the population attribute, feature, and label needs to be considered when the counterfactual sample is generated. Different processes for generating the counterfactual sample according to some embodiments of the present disclosure are described in detail below with reference to FIGS. 5A through 5C.

In some embodiments, when the intervening on the original sample is to change its population attribute, a counterfactual sample may be generated based on the changed population attribute and the original feature set (also referred to as a first feature set) of the original sample. In some embodiments, a new feature set (also referred to as a second feature set) of the counterfactual sample may be generated with a generative adversarial network (also referred to as a first generative adversarial network) based on the changed population attribute and the original feature set of the original sample, and a label of the counterfactual sample may be generated with the original model based on the new feature set of the counterfactual sample.

FIG. 5A illustrates a schematic diagram of a process 500 for generating a counterfactual sample by interfering with the population attribute of an original sample according to some embodiments of the present disclosure. As shown in FIG. 5A, an original sample 502 comprises a population attribute 504, a feature 505, a feature 506, a feature 506, and a label 508. It should be understood that the original sample 502 may have any number of population attributes, features and labels; only one population attribute, three features and one label are shown in FIG. 5A for ease of illustration, but this is not intended to limit the number of population attributes, features and labels. In FIG. 5A, the process 500 intervenes the population attribute 504 of the original sample 502 into a population attribute 514. As described upon describing FIG. 3B, when the population attribute of a sample is changed, both the feature and label of the sample are affected. Therefore, the process 500 needs to generate new features and a new label for the counterfactual sample. The process 500 may input the population attribute 514, feature 505, feature 506 and feature 507 into a generative adversarial network 509, and the generative adversarial network 509 outputs new feature 515, feature 51, and feature 517 based on these input information. The process 500 may then input new feature 515, feature 516 and feature 517 into an original model 510, and the original model 510 outputs a new label 518, thereby obtaining the counterfactual sample 512. The population attribute 514 of the counterfactual sample 512 is obtained by intervening, while the feature 515, feature 516, feature 517 and label 518 are new features and new label generated by the generative adversarial network 509 and the original model 510.

In FIG. 5A, the generative adversarial network 509 is trained for the case of changing the population attribute of the original sample. In some embodiments, to train the generative adversarial network 509, a first original sample subset and a second original sample subset may be determined from the original sample set, the population attribute of a sample in the first original sample subset having a first value and the population attribute of a sample in the second original sample subset having a second value. Then, a first population sample is obtained from the first original sample subset, and a target sample is generated based on a feature set of the first population sample and the second value of the population attribute. Then, a generative adversarial network may be trained based on the target sample and the second original sample subset.

In some embodiments, the distribution of feature X may be mapped from a population attribute A=a to a population attribute A=a′. Then, the original sample set is divided by features into two groups, namely, a first group with features X|A=Q and a second group with features X|A=a′. Then, a generator G_{a→a′} of the generative adversarial network 509 may be trained as the best transport mapping from features X|A=a to features X|A=a′, and meanwhile a discriminator D_{a→a′} of the generative adversarial network 509 is trained to determine whether a feature is a feature of a real sample or a feature generated by the generator G_{a→a′}, finally making the discriminator unable to distinguish between the mapped sample G_{a→a′}(X) and the real sample X|A=a′ by training. A training objective of this process may be expressed by the following Equation (11):

$${ℓ}_{{G}_{a \to {a}^{′}}} = \frac{1}{n} ( {\sum }_{x ∈ X \vert A = a} D ( G ( x ) ) + λ \cdot {\sum }_{x ∈ X \vert A = a} c ( x , G ( x ) ) ) \qquad ( 11 )$$

$${ℓ}_{{D}_{a \to {a}^{′}}} = \frac{1}{n} ( {\sum }_{{x}^{′} ∈ X \vert A = {a}^{′}} D ( {x}^{′} ) - {\sum }_{x ∈ X \vert A = a} D ( G ( x ) ) )$$

where n is the number of training samples and λ is the weight balancing the generator loss (i.e., [symbol] _{G}_{_{a→a′}}) and the distance cost function C(⋅) (i.e., [symbol] 2 norm) to make sure the mapped samples are not too far from the original distribution, and [symbol] _{D}_{_{a→a′}} is a discriminator loss.

In some embodiments, when the intervening on the original sample is to change its feature, a counterfactual sample may be generated based on the changed feature and the feature set of the original sample. In some embodiments, a feature set of the counterfactual sample may be generated with another generative adversarial network (also referred to as a second generative adversarial network) based on the changed feature and the feature set of the original sample, and a label of the counterfactual sample may be generated with the original model based on the feature set of the counterfactual sample.

FIG. 5B illustrates a schematic diagram of a process 520 of generating a counterfactual sample by intervening in a feature of an original sample according to some embodiments of the present disclosure. As shown in FIG. 5B, the original sample 502 comprises a population attribute 504, a feature 505, a feature 506, a feature 506 and a label 508. The process 520 intervenes the feature 505 of the original sample 502 as a feature 525 (e.g., in an example of predicting whether a user is interested in a car, the value of the feature “whether the number of outing in the past year exceeded 10” may be changed from “YES” to “NO”). As described in upon introducing FIG. 3C, when one feature of the sample is changed, other features and labels of the sample are affected at the same time. Therefore, the process 520 needs to generate new features and labels for the counterfactual sample. The process 520 may input feature 525, feature 506 and feature 507 into the generative adversarial network 529, and the generative adversarial network 529 outputs new feature 526 and feature 527 based on these input information. Then, the process 520 may input feature 525, feature 526 and feature 527 into the original model 510, and the original model 510 outputs a new label 528 to thereby obtain the counterfactual sample 522. The population attribute 504 of the counterfactual sample 522 does not change, the feature 525 is obtained by intervening, and the feature 526, the feature 527 and the label 528 are new features and new label generated by the generative adversarial network 509 and the original model 510.

In FIG. 5B, the generative adversarial network 529 is trained for the case of changing the feature of the original sample. In some embodiments, to train generative adversarial network 529, a first original sample subset and a second original sample subset may be determined from the original sample set, a specified features of a samples in the first original sample subset having a first value and a specified feature of a sample in the second original sample subset having a second value. Then, a first feature sample may be obtained from the first original sample subset, and a target sample may be generated based on the feature set of the first feature sample and the second value of the feature. Then, the generative adversarial network may be trained based on the target sample and the second original sample subset.

In some embodiments, the concept C is used to represent a feature of features X. When the concept C is changed, other features in features X needs to be changed accordingly. Similar to training the generative adversarial network 509, the generative adversarial network 529 may be trained to learn a mapping from a set of samples of features X|C=c to a set of samples of features X|C=c′, and meanwhile the generator and discriminator of the generative adversarial network 529 are trained to enable the generator to generate features deceiving the discriminator as new features (e.g., feature 526 and feature 527 in FIG. 5B) of the counterfactual sample.

In some embodiments, when the intervening on the original sample is to change its label, a counterfactual sample corresponding to the original sample may be generated based on the feature of the original sample and the changed label. FIG. 5C illustrates a schematic diagram of a process 540 for generating a counterfactual sample by intervening on a feature of an original sample according to some embodiments of the present disclosure. As shown in FIG. 5C, the original sample 502 comprises a population attribute 504, a feature 505, a feature 506, a feature 506 and a label 508. The process 540 intervenes the label 508 of the original sample 502 as the label 508 (e.g., in an example of predicting whether a user is interested in a car, the value of the label “whether the user is interested in car-related content” may be changed from “YES” to “NO”). As described upon introducing FIG. 3D, when the label of the sample is changed, the features of the sample are not affected. Therefore, the process 540 may generate the counterfactual sample 542 by simply replacing the label 508 of the original sample 502 with the label 548. The population attribute and features of the counterfactual sample 542 are identical to the original sample 502.

Various embodiments of generating the counterfactual sample described above take into account causal dependencies between the concepts (i.e., the population attribute, feature and label) of the sample data, and can improve the rationality of the counterfactual sample by regenerating the feature of the counterfactual sample, particularly in the case of changing the population attribute and feature of the original sample, so that the accuracy of the evaluation of the impact of the original sample on model fairness can be improved. In addition, when the original sample is repaired using the generated counterfactual sample, the counterfactual sample with higher rationality can improve the performance and accuracy of the retrained model.

The above describes the process of generating the counterfactual sample and how to calculate the fairness impact value based on the original model, the original sample and the generated counterfactual sample. After determining the fairness impact of the intervention on the original sample on the original model, the original sample set may be updated based on the determined fairness impact to generate a model with higher fairness.

In some embodiments, a plurality of fairness impact values corresponding to a plurality of original samples may be determined by respectively changing the labels of the plurality of original samples in the original sample set. Then, a plurality of target samples having the greatest corresponding fairness impact values may be determined from the plurality of original samples based on the plurality of fairness impact values. Then, an updated sample set may be generated by changing the labels of the plurality of target samples, and an updated model may be generated based on the updated sample set.

In some embodiments, a plurality of fairness impact values corresponding to a plurality of original samples may be determined by respectively changing values of specified features of the plurality of original samples in the original sample set. Then, a plurality of target samples having the greatest corresponding fairness impact values may be determined from the plurality of original samples based on the plurality of fairness impact values. Then, an updated sample set may be generated by removing the plurality of target samples from the original sample set, and an updated model may be generated based on the updated sample set.

In some embodiments, a plurality of fairness impact values corresponding to a plurality of original samples may be determined by respectively changing population attributes of the plurality of original samples in the original sample set. When a proportion of fairness impact values greater than a predetermined value among the plurality of fairness impact values is greater than a predetermined proportion, an updated sample set may be resampled from different populations, and an updated model is generated based on the updated sample set.

In these ways, mislabeled labels in the original sample set can be repaired, discrimination and remedial metrics can be taken against fairness poisoning attack, and imbalanced sampling distributions in the training sample set can be discovered, so that the population balance of the sample set can be optimized by replacing the original sample with the counterfactual sample or re-collecting the training samples.

A detailed derivation process of Equation (2) will be described below. Assume the risk of a model θ may be expressed as R(θ):=1/nΣᵢ₌₁ⁿ [symbol] (zₜᵣ;θ), and the model trained on the complete training sample set may be expressed as \hat{θ}:=argmin_{θ}R(θ). If a weight wᵢ∈[0, 1] is assigned to each sample i∈ [symbol] and then weighted by some small positive number ϵ, the resulting model can be expressed by the following Equation (12):

$${\hat{θ}}_{𝒦} := arg {min}_{θ} \{ R ( θ ) + ϵ \cdot {\sum }_{i ∈ 𝒦} {w}_{i} \cdot ℓ ( {z}_{i}^{tr} ; \hat{θ} ) \} \qquad ( 12 )$$

According to the first order condition of \hat{θ} [symbol] , the following Equation (13) may be obtained:

$$0 = ▽ R ( {\hat{θ}}_{𝒦} ) + ϵ \cdot {\sum }_{i ∈ 𝒦} {w}_{i} \cdot ▽ℓ ( {z}_{i}^{tr} ; {\hat{θ}}_{𝒦} ) \qquad ( 13 )$$

When ϵ→( ), the following Equation (14) may be obtained with the Taylor expansion (and the first-order approximation):

$$0 \approx ( Δ \text{?} ( \text{?} ) + \text{?} \sum \text{?} \text{?} \cdot Δ \text{?} ( \text{?} \text{?} \text{?} ) ) + ( Δ \text{?} \text{?} \text{?} + \text{?} \sum \text{?} \text{?} \cdot Δ \text{?} \text{?} ( \text{?} \text{?} \text{?} ) ) \cdot ( \text{?} \text{?} - \text{?} ) \qquad ( 14 )$$

$$\text{?} \text{indicates text missing or illegible when filed}$$

According to the first order condition of \hat{θ}, ∇R(\hat{θ})=0 may be obtained, and then these terms are rearranged to obtain the following Equation (15):

$$\frac{{\hat{θ}}_{𝒦} - \hat{θ}}{ϵ} = - {( {H}_{\hat{θ}} + ϵ \cdot {\sum }_{i ∈ 𝒦} {w}_{i} \cdot {▽}^{2} ℓ ( {z}_{i}^{tr} ; \hat{θ} ) )}^{- 1} \cdot ( {\sum }_{i ∈ 𝒦} {w}_{i} \cdot ▽ℓ ( {z}_{i}^{tr} ; \hat{θ} ) ) \qquad ( 15 )$$

The following equation (16) may be obtained by taking the limit ϵ→( ) on both sides of Equation (15):

$$\frac{\partial {\hat{θ}}_{𝒦}}{{\partial }_{ϵ}} {\vert}_{ϵ = 0} = - {H}_{\hat{θ}}^{- 1} \cdot ( {\sum }_{i ∈ 𝒦} {w}_{i} \cdot ▽ℓ ( {z}_{i}^{tr} ; \hat{θ} ) ) \qquad ( 16 )$$

Finally, the fairness impact of assigning training sample i in population/C with weight wᵢ may be determined by the following Equations (17), (18), (19) and (20):

$$infl ( {D}_{val} , 𝒦 , \hat{θ} ) := {ℓ}_{fair} ( \hat{θ} ) - {ℓ}_{fair} ( {\hat{θ}}_{k} ) \qquad ( 17 )$$

$$\approx \frac{\partial {ℓ}_{fair} ( {\hat{θ}}_{𝒦} )}{\partial ϵ} {\vert}_{ϵ = 0} \qquad ( 18 )$$

$$= {∇}_{θ} {{ℓ}_{fair} ( \hat{θ} )}^{⊤} \frac{{\hat{θ}}_{𝒦}}{\partial ϵ} {\vert}_{ϵ = 0} \qquad ( 19 )$$

$$= - {∇}_{θ} {{ℓ}_{fair} ( \hat{θ} )}^{⊤} {H}_{\hat{θ}}^{- 1} ( {\sum }_{i ∈ 𝒦} {w}_{i} ▽ℓ ( {z}_{i}^{tr} ; \hat{θ} ) ) \qquad ( 20 )$$

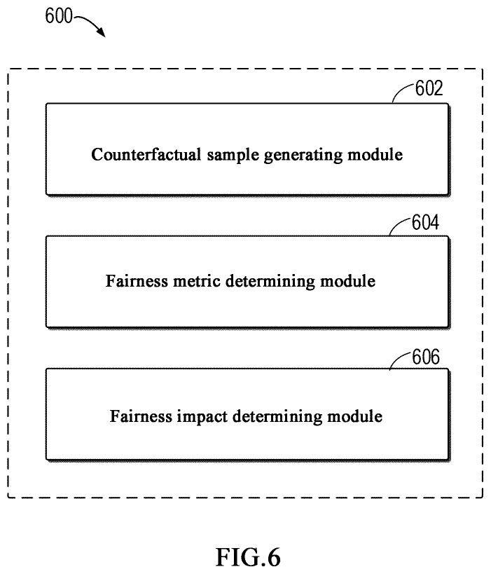

FIG. 6 illustrates a block diagram of an apparatus 600 for determining fairness impact of a sample on a model according to some embodiments of the present disclosure. As shown in FIG. 6, the apparatus 600 comprises a counterfactual sample generating module 602 configured to generate a counterfactual sample by adjusting an original sample in an original sample set, the original sample set being used for generating an original model for performing a classification task. The apparatus 600 further comprises a fairness metric determining module 604 configured to determine a fairness metric of the original model on a validation sample set. In addition, the apparatus 600 further comprises a fairness impact determining module 606 configured to determine an impact of the original sample on the original model based on the fairness metric, the original sample, and the counterfactual sample.

It may be appreciated that at least one of many advantages that can be realized with the method or process as described above can be realized with the apparatus 600 of the present disclosure. For example, the impact of each training sample on model fairness can be determined to help a practitioner accurately locate those training samples that have the greatest impact on model fairness so that the practitioner can improve model fairness by repairing those training samples.

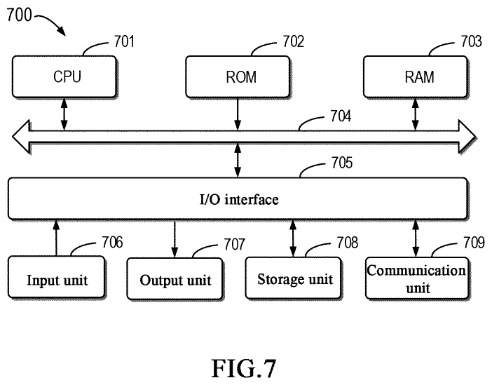

FIG. 7 shows a block diagram of an electronic device 700 according to some embodiments of the present disclosure. The device 700 may be a device or apparatus described in embodiments of the present disclosure. As shown in FIG. 7, the device 700 comprises a Central Processing Unit (CPU) and/or a Graphics Processing Unit (GPU) 701, which may perform various suitable actions and processes according to computer program instructions stored in a Read-Only Memory (ROM) 702 or loaded from a storage unit 708 into a Random Access Memory (RAM) 703. In the RAM 703, various programs and data needed by the device 700 in operations may also be stored. The CPU/GPU 701, ROM 702 and RAM 703 are connected to one another via a bus 704. An input/output (I/O) interface 705 is also connected to the bus 704. Although not shown in FIG. 7, the device 700 may further include a coprocessor.

Various components in the device 700 are connected to an I/O interface 705, including: an input unit 706 such as a keyboard, a mouse, or the like; an output unit 707 such as various types of displays, speakers, and the like; a storage unit 708 such as a magnetic disk, an optical disk, or the like; and a communication unit 709 such as a network card, a modem, a wireless communication transceiver, or the like. The communication unit 709 allows the device 700 to exchange information/data with other devices through a computer network such as the Internet and/or various telecommunications networks.

The various methods or processes described above may be performed by the CPU/GPU 701. For example, in some embodiments, the method may be implemented as a computer software program tangibly embodied on a non-transitory machine-readable medium, such as the storage unit 708. In some embodiments, part or all of the computer program may be loaded into and/or installed onto the device 700 via the ROM 702 and/or the communication unit 709. When the computer program is loaded into RAM 703 and executed by CPU/GPU 701, one or more steps or actions in the above-described methods or processes may be performed.

In some embodiments, the methods and processes described above may be implemented as a non-transitory computer program product. The computer program product may include a computer readable storage medium having computer readable program instructions embodied thereon for performing aspects of the present disclosure.

The non-transitory computer readable storage medium may be a tangible device that may hold and store instructions for use by an instruction execution device. The computer readable storage medium may be, for example, but not limited to, an electrical storage device, a magnetic storage device, an optical storage device, an electromagnetic storage device, a semiconductor storage device, or any suitable combination of the foregoing. More specific examples (a non-exhaustive list) of the computer-readable storage medium would include the following: a portable computer disk, a hard disk, a Random Access Memory (RAM), a Read-Only Memory (ROM), an Erasable Programmable Read-Only Memory (EPROM or flash memory), a Static Random Access Memory (SRAM), a Portable Compact Disk Read-Only Memory (CD-ROM), a Digital Versatile Disks (DVD), a memory stick, a floppy disk, a mechanically encoded device such as punch-cards or raised structures in a groove having instructions recorded thereon, and any suitable combination of the foregoing. The computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention can be assembler instructions, instruction-set-architecture (ISA) instructions, machine instructions, machine dependent instructions, microcode, firmware instructions, state-setting data, or either source code or object code written in any combination of one or more programming languages, including an object oriented programming language and procedural programming languages. The computer readable program instructions can execute entirely on the user's computer, partly on the user's computer, as a stand-alone software package, partly on the user's computer and partly on a remote computer or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In some embodiments, electronic circuitry including, for example, programmable logic circuitry, field-programmable gate arrays (FPGA), or programmable logic arrays (PLA) can execute the computer readable program instructions by utilizing state information of the computer readable program instructions to personalize the electronic circuitry, in order to perform aspects of the present disclosure.

These computer readable program instructions can be provided to a processor of a general purpose computer, special purpose computer, or other programmable data processing apparatus to produce a machine, such that the instructions, which execute via the processor of the computer or other programmable data processing apparatus, create method for implementing the functions/acts specified in the flowchart and/or block diagram block or blocks. These computer readable program instructions can also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions can also be loaded onto a computer, other programmable data processing apparatus, or other device to cause a series of operational acts to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams can represent a module, segment, or portion of instructions, which comprises one or more executable instructions for implementing the specified logical function(s). In some alternative implementations, the functions noted in the blocks can occur out of the order noted in the Figures. For example, two blocks shown in succession can, in fact, be executed substantially concurrently, or the blocks can sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Some example implementations of the present disclosure are listed below:

Example 1. A method for determining fairness impact of a sample on a model, comprising:
generating a counterfactual sample by adjusting an original sample in an original sample set, the original sample set being used for generating an original model for performing a classification task;
determining a fairness metric of the original model on a validation sample set; and
determining fairness impact of the original sample on the original model based on the fairness metric, the original sample, and the counterfactual sample.

Example 2. The method according to Example 1, wherein determining the impact on fairness comprises:
determining, based on the original sample, a first loss using a loss function of the original model;
determining, based on the counterfactual sample, a second loss using the loss function; and
determining a fairness impact value indicative of the fairness impact based on the fairness metric, the first loss, and the second loss.

Example 3. The method according to Examples 1-2, wherein determining the fairness impact value comprises:
generating a plurality of losses corresponding to a plurality of original samples in the original sample set by using the loss function;
determining a Hessian matrix for the original model based on the plurality of losses; and
determining the fairness impact value based on the Hessian matrix, the fairness metric, the first loss, and the second loss.

Example 4. The method according to Examples 1-3, wherein adjusting the original sample comprises one of: changing a population attribute of the original sample, changing a feature of the original sample, changing a label of the original sample, or removing the original sample from the original sample set.

Example 5. The method according to Examples 1-4, wherein generating the counterfactual sample comprises:
in response to the adjustment for the original sample being changing the population attribute of the original sample, generating the counterfactual sample based on the changed population attribute and a first feature set of the original sample.

Example 6. The method according to Examples 1-5, wherein generating the counterfactual sample further comprises:
generating, based on the changed population attribute and the first feature set of the original sample, a second feature set of the counterfactual sample by using a first generative adversarial network; and
generating, based on the second feature set of the counterfactual sample, a label of the counterfactual sample by using the original model.

Example 7. The method according to Examples 1-6, further comprising:
determining a first original sample subset and a second original sample subset from the original sample set, a population attribute of a sample in the first original sample subset having a first value, and a population attribute of a sample in the second original sample subset having a second value;
obtaining a first population sample in the first original sample subset;
generating a target sample based on a feature set of the first population sample and the second value of the population attribute; and
generating the first generative adversarial network based on the target sample and the second original sample subset.

Example 8. The method according to Examples 1-7, wherein generating the counterfactual sample comprises:
in response to the adjustment for the original sample being changing a feature of the original sample, generating the counterfactual sample based on the changed feature and the first feature set of the original sample.

Example 9. The method according to claims 1-8, wherein generating the counterfactual sample comprises:
generating, based on the changed feature and the first feature set of the original sample, a second feature set of the counterfactual sample by using a second generative adversarial network; and
generating, based on the second feature set of the counterfactual sample, a label of the counterfactual sample by using the original model.

Example 10. The method according to Examples 1-9, further comprising:
determining a first original sample subset and a second original sample subset from the original sample set, the feature of a sample in the first original sample subset having a first value and the feature of a sample in the second original sample subset having a second value;
obtaining a first feature sample in the first original sample subset;
generating a target sample based on a feature set of the first feature sample and the second value of the feature; and
generating the second generative adversarial network based on the target sample and the second original sample subset.

Example 11. The method according to Examples 1-10, wherein generating the counterfactual sample comprises:
in response to the adjustment for the original sample being changing a label of the original sample, generating a counterfactual sample corresponding to the original sample based on a feature set of the original sample and the changed label.

Example 12. The method according to Examples 1-11, further comprising:
determining a plurality of fairness impact values corresponding to the plurality of original samples by changing labels of the plurality of original samples in the original sample set respectively;
determining, based on the plurality of fairness impact values, a plurality of target samples having largest corresponding fairness impact values from the plurality of original samples;
generating an updated sample set by changing the labels of the plurality of target samples; and
generating an updated model based on the updated sample set.

Example 13. The method according to Examples 1-12, further comprising:
determining a plurality of fairness impact values corresponding to the plurality of original samples by changing values of specified features of the plurality of original samples in the original sample set respectively;
determining, based on the plurality of fairness impact values, a plurality of target samples having largest corresponding fairness impact values from the plurality of original samples;
generating an updated sample set by removing the plurality of target samples from the original sample set; and
generating an updated model based on the updated sample set.

Example 14. The method according to Examples 1-13, further comprising:
determining a plurality of fairness impact values corresponding to the plurality of original samples by changing population attributes of the plurality of original samples in the original sample set respectively;
resampling an updated sample set from a different population in response to a proportion of fairness impact values greater than a predetermined value among the plurality of fairness impact values being greater than a predetermined proportion; and
generating an updated model based on the updated sample set.

Example 15. An apparatus for determining fairness impact of a sample on a model, comprising:
a counterfactual sample generating module configured to generate a counterfactual sample by adjusting an original sample in an original sample set, the original sample set being used for generating an original model for performing a classification task;
a fairness metric determining module configured to determine a fairness metric of the original model on a validation sample set; and
a fairness impact determining module configured to determine an impact of the original sample on the original model based on the fairness metric, the original sample, and the counterfactual sample.

Example 16. The apparatus according to Example 15, wherein determining the impact on fairness comprises:
a first loss determining module configured to determine, based on the original sample, a first loss using a loss function of the original model;
a second loss determining module configured to determine, based on the counterfactual sample, a second loss using the loss function; and
an impact value determining module configured to determine a fairness impact value indicative of the fairness impact based on the fairness metric, the first loss, and the second loss.

Example 17. The apparatus according to Examples 15-16, wherein determining the fairness impact value comprises:
a loss function using module configured to generate a plurality of losses corresponding to a plurality of original samples in the original sample set by using the loss function;
a Hessian matrix determining module configured to determine a Hessian matrix for the original model based on the plurality of losses; and
a Hessian matrix using module configured to determine the fairness impact value based on the Hessian matrix, the fairness metric, the first loss, and the second loss.

Example 18. The apparatus according to Examples 15-17, wherein adjusting the original sample comprises one of: changing a population attribute of the original sample, changing a feature of the original sample, changing a label of the original sample, or removing the original sample from the original sample set.

Example 19. The apparatus according to Examples 15-18, wherein generating the counterfactual sample comprises:
a population attribute intervening module configured to, in response to the adjustment for the original sample being changing the population attribute of the original sample, generate the counterfactual sample based on the changed population attribute and a first feature set of the original sample.

Example 20. The apparatus according to Examples 15-19, wherein generating the counterfactual sample further comprises:
a first network using module configured to generate, based on the changed population attribute and the first feature set of the original sample, a second feature set of the counterfactual sample by using a first generative adversarial network; and
a first label generating module configured to, generate, based on the second feature set of the counterfactual sample, a label of the counterfactual sample by using the original model.

Example 21. The apparatus according to Examples 15-20, further comprising:
a first subset determining module configured to determine a first original sample subset and a second original sample subset from the original sample set, a population attribute of a sample in the first original sample subset having a first value, and a population attribute of a sample in the second original sample subset having a second value;
a population sample obtaining module configured to obtain a first population sample in the first original sample subset;
a first target generating module configured to generate a target sample based on a feature set of the first population sample and the second value of the population attribute; and
a first network generating module configured to generate the first generative adversarial network based on the target sample and the second original sample subset.

Example 22. The apparatus according to Examples 15-21, wherein generating the counterfactual sample comprises:
a sample feature intervening module configured to, in response to the adjustment for the original sample being changing a feature of the original sample, generate the counterfactual sample based on the changed feature and the first feature set of the original sample.

Example 23. The apparatus according to claims 15-22, wherein generating the counterfactual sample comprises:
a second network using module configured to generate, based on the changed feature and the first feature set of the original sample, a second feature set of the counterfactual sample by using a second generative adversarial network; and
a second label generating module configured to generate, based on the second feature set of the counterfactual sample, a label of the counterfactual sample by using the original model.

Example 24. The apparatus according to Examples 15-23, further comprising:
a second subset determining module configured to determine a first original sample subset and a second original sample subset from the original sample set, the feature of a sample in the first original sample subset having a first value and the feature of a sample in the second original sample subset having a second value;
a feature sample obtaining module configured to obtain a first feature sample in the first original sample subset;
a second target generating module configured to generate a target sample based on a feature set of the first feature sample and the second value of the feature; and
a second network generating module configured to generate the second generative adversarial network based on the target sample and the second original sample subset.

Example 25. The apparatus according to Examples 15-24, wherein generating the counterfactual sample comprises:
a sample label intervening module configured to, in response to the adjustment for the original sample being changing a label of the original sample, generate a counterfactual sample corresponding to the original sample based on a feature set of the original sample and the changed label.

Example 26. The apparatus according to Examples 15-22, further comprising:
a label intervention application module configured to determine a plurality of fairness impact values corresponding to the plurality of original samples by changing labels of the plurality of original samples in the original sample set respectively;
a first impact value comparing module configured to determine, based on the plurality of fairness impact values, a plurality of target samples having largest corresponding fairness impact values from the plurality of original samples;
a first update sample generating module configured to generate an updated sample set by changing the labels of the plurality of target samples; and
a first update module generating module configured to generate an updated model based on the updated sample set.

Example 27. The apparatus according to Examples 15-26, further comprising:
a feature intervention application module configure to determine a plurality of fairness impact values corresponding to the plurality of original samples by changing values of specified features of the plurality of original samples in the original sample set respectively;
a second impact value comparing module configured to determine, based on the plurality of fairness impact values, a plurality of target samples having largest corresponding fairness impact values from the plurality of original samples;
a second update sample generating module configured to generate an updated sample set by removing the plurality of target samples from the original sample set; and
a second update module generating module configured to generate an updated model based on the updated sample set.

Example 28. The apparatus according to Examples 15-27, further comprising:
a population attribute application module configured to determine a plurality of fairness impact values corresponding to the plurality of original samples by changing population attributes of the plurality of original samples in the original sample set respectively;
a third update sample generating module configured to resample an updated sample set from a different population in response to a proportion of fairness impact values greater than a predetermined value among the plurality of fairness impact values being greater than a predetermined proportion; and
a third update module generating module configured to generate an updated model based on the updated sample set.

Example 29. An electronic device, comprising:
a processor; and
a memory coupled to the processor, the memory having stored therein instructions that, when executed by the processor, cause the electronic device to perform acts, the acts comprising:
generating a counterfactual sample by adjusting an original sample in an original sample set, the original sample set being used for generating an original model for performing a classification task;
determining a fairness metric of the original model on a validation sample set; and
determining fairness impact of the original sample on the original model based on the fairness metric, the original sample, and the counterfactual sample.

Example 30. The device according to Example 29, wherein determining the impact on fairness comprises:
determining, based on the original sample, a first loss using a loss function of the original model;
determining, based on the counterfactual sample, a second loss using the loss function; and
determining a fairness impact value indicative of the fairness impact based on the fairness metric, the first loss, and the second loss.

Example 31. The device according to Examples 29-30, wherein determining the fairness impact value comprises:
generating a plurality of losses corresponding to a plurality of original samples in the original sample set by using the loss function;
determining a Hessian matrix for the original model based on the plurality of losses; and
determining the fairness impact value based on the Hessian matrix, the fairness metric, the first loss, and the second loss.

Example 32. The device according to Examples 29-31, wherein adjusting the original sample comprises one of: changing a population attribute of the original sample, changing a feature of the original sample, changing a label of the original sample, or removing the original sample from the original sample set.

Example 33. The device according to Examples 29-32, wherein generating the counterfactual sample comprises:
in response to the adjustment for the original sample being changing the population attribute of the original sample, generating the counterfactual sample based on the changed population attribute and a first feature set of the original sample.

Example 34. The device according to Examples 29-33, wherein generating the counterfactual sample further comprises:
generating, based on the changed population attribute and the first feature set of the original sample, a second feature set of the counterfactual sample by using a first generative adversarial network; and
generating, based on the second feature set of the counterfactual sample, a label of the counterfactual sample by using the original model.

Example 35. The device according to Examples 29-34, further comprising:
determining a first original sample subset and a second original sample subset from the original sample set, a population attribute of a sample in the first original sample subset having a first value, and a population attribute of a sample in the second original sample subset having a second value;
obtaining a first population sample in the first original sample subset;
generating a target sample based on a feature set of the first population sample and the second value of the population attribute; and
generating the first generative adversarial network based on the target sample and the second original sample subset.

Example 36. The device according to Examples 29-35, wherein generating the counterfactual sample comprises:
in response to the adjustment for the original sample being changing a feature of the original sample, generating the counterfactual sample based on the changed feature and the first feature set of the original sample.

Example 37. The device according to claims 29-36, wherein generating the counterfactual sample comprises:
generating, based on the changed feature and the first feature set of the original sample, a second feature set of the counterfactual sample by using a second generative adversarial network; and
generating, based on the second feature set of the counterfactual sample, a label of the counterfactual sample by using the original model.

Example 38. The method according to Examples 29-37, further comprising:
determining a first original sample subset and a second original sample subset from the original sample set, the feature of a sample in the first original sample subset having a first value and the feature of a sample in the second original sample subset having a second value;
obtaining a first feature sample in the first original sample subset;
generating a target sample based on a feature set of the first feature sample and the second value of the feature; and
generating the second generative adversarial network based on the target sample and the second original sample subset.

Example 39. The method according to Examples 29-38, wherein generating the counterfactual sample comprises:
in response to the adjustment for the original sample being changing a label of the original sample, generating a counterfactual sample corresponding to the original sample based on a feature set of the original sample and the changed label.

Example 40. The device according to Examples 29-39, further comprising:
determining a plurality of fairness impact values corresponding to the plurality of original samples by changing labels of the plurality of original samples in the original sample set respectively;
determining, based on the plurality of fairness impact values, a plurality of target samples having largest corresponding fairness impact values from the plurality of original samples;
generating an updated sample set by changing the labels of the plurality of target samples; and
generating an updated model based on the updated sample set.

Example 41. The device according to Examples 29-40, further comprising:
determining a plurality of fairness impact values corresponding to the plurality of original samples by changing values of specified features of the plurality of original samples in the original sample set respectively;
determining, based on the plurality of fairness impact values, a plurality of target samples having largest corresponding fairness impact values from the plurality of original samples;
generating an updated sample set by removing the plurality of target samples from the original sample set; and
generating an updated model based on the updated sample set.

Example 42. The device according to Examples 29-41, further comprising:
determining a plurality of fairness impact values corresponding to the plurality of original samples by changing population attributes of the plurality of original samples in the original sample set respectively;
resampling an updated sample set from a different population in response to a proportion of fairness impact values greater than a predetermined value among the plurality of fairness impact values being greater than a predetermined proportion; and
generating an updated model based on the updated sample set.

Although the subject matter has been described in language specific to structural features and/or methodological acts, it is to be understood that the subject matter specified in the appended claims is not necessarily limited to the specific features or acts described above. Rather, the specific features and acts described above are disclosed as example forms of implementing the claims.

1. A method for determining fairness impact of a sample on a model, comprising:
generating a counterfactual sample by adjusting an original sample in an original sample set, the original sample set being used for generating an original model for performing a classification task;
determining a fairness metric of the original model on a validation sample set; and
determining fairness impact of the original sample on the original model based on the fairness metric, the original sample, and the counterfactual sample.

2. The method according to claim 1, wherein determining the fairness impact comprises:
determining, based on the original sample, a first loss using a loss function of the original model;
determining, based on the counterfactual sample, a second loss using the loss function; and
determining a fairness impact value indicative of the fairness impact based on the fairness metric, the first loss, and the second loss.

3. The method according to claim 2, wherein determining the fairness impact value comprises:
generating a plurality of losses corresponding to a plurality of original samples in the original sample set by using the loss function;
determining a Hessian matrix for the original model based on the plurality of losses; and
determining the fairness impact value based on the Hessian matrix, the fairness metric, the first loss, and the second loss.

4. The method according to claim 1, wherein adjusting the original sample comprises one of: changing a population attribute of the original sample, changing a feature of the original sample, changing a label of the original sample, or removing the original sample from the original sample set.

5. The method according to claim 4, wherein generating the counterfactual sample comprises:
in response to the adjustment for the original sample being changing the population attribute of the original sample, generating the counterfactual sample based on the changed population attribute and a first feature set of the original sample.

6. The method according to claim 5, wherein generating the counterfactual sample further comprises:
generating, based on the changed population attribute and the first feature set of the original sample, a second feature set of the counterfactual sample by using a first generative adversarial network; and
generating, based on the second feature set of the counterfactual sample, a label of the counterfactual sample by using the original model.

7. The method according to claim 6, further comprising:
determining a first original sample subset and a second original sample subset from the original sample set, a population attribute of a sample in the first original sample subset having a first value, and a population attribute of a sample in the second original sample subset having a second value;
obtaining a first population sample in the first original sample subset;
generating a target sample based on a feature set of the first population sample and the second value of the population attribute; and
generating the first generative adversarial network based on the target sample and the second original sample subset.

8. The method according to claim 4, wherein generating the counterfactual sample comprises:
in response to the adjustment for the original sample being changing a feature of the original sample, generating the counterfactual sample based on the changed feature and the first feature set of the original sample.

9. The method according to claim 8, wherein generating the counterfactual sample comprises:
generating, based on the changed feature and the first feature set of the original sample, a second feature set of the counterfactual sample by using a second generative adversarial network; and
generating, based on the second feature set of the counterfactual sample, a label of the counterfactual sample by using the original model.

10. The method according to claim 9, further comprising:
determining a first original sample subset and a second original sample subset from the original sample set, the feature of a sample in the first original sample subset having a first value and the feature of a sample in the second original sample subset having a second value;
obtaining a first feature sample in the first original sample subset;
generating a target sample based on a feature set of the first feature sample and the second value of the feature; and
generating the second generative adversarial network based on the target sample and the second original sample subset.

11. The method according to claim 4, wherein generating the counterfactual sample comprises:
in response to the adjustment for the original sample being changing a label of the original sample, generating a counterfactual sample corresponding to the original sample based on a feature set of the original sample and the changed label.

12. The method according to claim 1, further comprising:
determining a plurality of fairness impact values corresponding to the plurality of original samples by changing labels of the plurality of original samples in the original sample set respectively;
determining, based on the plurality of fairness impact values, a plurality of target samples having largest corresponding fairness impact values from the plurality of original samples;
generating an updated sample set by changing the labels of the plurality of target samples; and
generating an updated model based on the updated sample set.

13. The method according to claim 1, further comprising:
determining a plurality of fairness impact values corresponding to the plurality of original samples by changing values of specified features of the plurality of original samples in the original sample set respectively;
determining a plurality of target samples having largest corresponding fairness impact values from the plurality of original samples based on the plurality of fairness impact values;
generating an updated sample set by removing the plurality of target samples from the original sample set; and
generating an updated model based on the updated sample set.

14. The method according to claim 1, further comprising:
determining a plurality of fairness impact values corresponding to the plurality of original samples by changing population attributes of the plurality of original samples in the original sample set respectively;
resampling an updated sample set from a different population in response to a proportion of fairness impact values greater than a predetermined value among the plurality of fairness impact values being greater than a predetermined proportion; and
generating an updated model based on the updated sample set.

15. An electronic device, comprising:
a processor; and
a memory coupled with the processor, the memory having instructions stored therein, the instructions, when executed by the processor, causing the processor to:
generate a counterfactual sample by adjusting an original sample in an original sample set, the original sample set being used for generating an original model for performing a classification task;
determine a fairness metric of the original model on a validation sample set; and
determine fairness impact of the original sample on the original model based on the fairness metric, the original sample, and the counterfactual sample.

16. The device according to claim 15, wherein the instructions causing the processor to determine the fairness impact comprises instructions causing the processor to:
determine, based on the original sample, a first loss using a loss function of the original model;
determine, based on the counterfactual sample, a second loss using the loss function; and
determine a fairness impact value indicative of the fairness impact based on the fairness metric, the first loss, and the second loss.

17. The device according to claim 16, wherein the instructions causing the processor to determine the fairness impact value comprises instructions causing the processor to:
generate a plurality of losses corresponding to a plurality of original samples in the original sample set by using the loss function;
determine a Hessian matrix for the original model based on the plurality of losses; and
determine the fairness impact value based on the Hessian matrix, the fairness metric, the first loss, and the second loss.

18. The device according to claim 15, wherein adjusting the original sample comprises one of: changing a population attribute of the original sample, changing a feature of the original sample, changing a label of the original sample, or removing the original sample from the original sample set.

19. The device according to claim 18, wherein the instructions causing the processor to generate the counterfactual sample comprises instructions causing the processor to:
in response to the adjustment for the original sample being changing the population attribute of the original sample, generate the counterfactual sample based on the changed population attribute and a first feature set of the original sample.

20. A non-transitory computer readable storage medium having computer-executable instructions stored thereon, wherein the compute-executable instructions, when executed by a processor, causes the processor to:
generate a counterfactual sample by adjusting an original sample in an original sample set, the original sample set being used for generating an original model for performing a classification task;
determine a fairness metric of the original model on a validation sample set; and
determine fairness impact of the original sample on the original model based on the fairness metric, the original sample, and the counterfactual sample.
